(19) United States
(12) Patent Application Publication
(10) Pub. No.: US 2013/0149420 A1
(43) Pub. Date: Jun. 13, 2013

(54) Methods and Devices for Forming Articles

(71) Applicants: Bruce Dorendorf, Winnebago, MN (US); Brian Caldwell, Mapleton, MN (US)

(72) Inventors: Bruce Dorendorf, Winnebago, MN (US); Brian Caldwell, Mapleton, MN (US)

(21) Appl. No.: 13/472,457

(22) Filed: May 15, 2012

Related U.S. Application Data
(60) Provisional application No. 61/486,402, filed on May 16, 2011.

(51) Int. Cl. A23K 1/00

(52) U.S. Cl. CPC A23K 1/002
USPC 426/285; 425/447

(57) ABSTRACT

The present invention relates to methods and devices for the formation of articles, for example pelletized articles, for use as animal feed or otherwise. In one exemplary embodiment, the present invention provides a process of forming animal feed. The process includes forming a mixture of hydrated alginate. The process further includes forming a mixture of ingredients to be pelletized, the mixture of ingredients being placed in a preconditioning chamber of a forming device. The process further includes atomizing and injecting the hydrated alginate into the preconditioning chamber to coat the mixture of ingredients. The process still further includes pelletizing the mixture of alginate coated ingredients, wherein the volume of atomized hydrated alginate applied to the mixture of ingredients is based upon one or more characteristics of the ingredients, one or more operating conditions of the forming device or both.

### CLAIM OF PRIORITY

The present application claims priority to U.S. Patent Application No. 61/486,402, to Dorendorf et al., filed May 16, 2011, the contents of which are hereby incorporated by reference in its entirety for all purposes.

### CROSS-REFERENCE TO RELATED APPLICATION

The present application is related to U.S. patent application Ser. No. 11/768,446, to Fajt et al., filed Jun. 26, 2007, now U.S. Patent Publication No. 2007/0298082, and U.S. patent application Ser. No. 13/175,645, to Dorendorf et al., filed Jul. 1, 2011, now U.S. Patent Publication No. 2012/0003366, the contents of both are hereby incorporated by reference in their entirety for all purposes.

### FIELD OF THE INVENTION

The present invention relates to methods and devices for the formation of articles, such as pelletized articles, for use as animal feed or otherwise.

### BACKGROUND

Forming devices, such as pellet mills, extruders or otherwise, provide a continuous production of individual articles, such as pellets, for various applications including animal feed, plant food, bio-fuel or otherwise. In certain situations, steam or other ingredients are applied or added to the ingredients during forming. In commonly owned U.S. Patent Publication No. 2007/0298082, indicated above, the use of alginates as a lubricant and retention agent is taught. Also, in commonly owned U.S. Patent Publication No. 2012/0003366, indicated above, methods and devices for the preparation and delivery of alginate to a forming device is taught. The features of the present invention provide additional methods and devices for the preparation and delivery of alginate to ingredients for retaining and lubricating such ingredients during and after formation.

The features of the present invention provide improved methods and devices for the preparation and application of alginate to ingredients to be pellatized. Such methods and devices provide enhanced pellet durability and quality.

### SUMMARY OF THE INVENTION

The present invention relates to methods and devices for the formation of articles, for example pelletized articles, for use as animal feed or otherwise. In one exemplary embodiment, the present invention provides a process of forming animal feed. The process includes forming a mixture of hydrated alginate. The process further includes forming a mixture of ingredients to be pelletized, the mixture of ingredients being placed in a preconditioning chamber of a forming device. The process further includes atomizing and injecting the hydrated alginate into the preconditioning chamber to coat the mixture of ingredients. The process further includes pelletizing the mixture of alginate coated ingredients, wherein the volume of atomized hydrated alginate applied to the mixture of ingredients is based upon one or more characteristics of the ingredients, one or more operating conditions of the forming device or both.

In another exemplary embodiment, the present invention provides a pelletization system for mass production of articles. The system includes a hydration unit configured to receive and mix an alginate powder with a hydration fluid to form a hydrated alginate mixture. The system further includes a preconditioning chamber for treatment of ingredients to be pelletized. The preconditioning chamber includes a plurality of atomization nozzles fluidly connected to the hydration unit for atomization and injection of the hydrated alginate mixture onto the ingredients within the preconditioning chamber. The system further includes a forming device linkably attached to the preconditioning chamber to receive ingredients therefrom. The forming device is configured to form articles from the ingredients received from the preconditioning chamber.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIG. 1 illustrates a schematic view of a forming system according to an exemplary embodiment of the present invention;

FIG. 2 illustrates a schematic view of another forming system according to an exemplary embodiment of the present invention;

FIG. 3 illustrates a schematic view of four atomizing nozzle configurations according to the teachings of the present invention;

FIG. 4 illustrates a perspective view of a forming device and a first atomization nozzle configuration according to the teachings of the present invention;

FIG. 5 illustrates an internal perspective view of the forming device shown in FIG. 4;

FIG. 6 illustrates a perspective view of another forming device and a second unattached atomization nozzle configuration according to the teachings of the present invention;

FIG. 7 illustrates a perspective view of the exemplary atomization nozzle configuration shown in FIG. 6;

FIG. 8 illustrates a partial perspective view of a forming device and a third exemplary atomization nozzle configuration according to the teachings of the present invention;

FIG. 9 illustrates an enlarged view of one of the attached atomization nozzle configuration shown in FIG. 8; and

FIG. 10 illustrates a fourth exemplary atomization nozzle configuration according to the teachings of the present invention.

### DESCRIPTION OF THE PREFERRED EMBODIMENTS

In general, the present invention provides methods and devices for forming articles, particularly pellet-like articles, for use in various applications including animal feed, bio-fuel, biomass, pet products (e.g. kitty litter, pet food, etc.), erosion control products, fertilizers, medicinal products, or otherwise. Through the features of the present invention one or more of the following advantages are achieved: higher formation rate of pellets, improved pellet quality, improved pelletization efficiency (e.g. lower manufacturing cost and power consumption), higher availability of ingredients which may be pelletized, improved pellet durability, reduced equipment wear, improved molecular binding, micro coating of heat sensitive ingredients, improved binding ability of high fat content ingredients and other ingredients that are difficult to bind together. Other advantages will be appreciated as shown and described herein.

The advancements of the present invention are predicated upon the use of hydrated alginate as a lubricant and retention agent for the pelletization of ingredients, particularly animal feed or otherwise described herein. In one particular aspect, the advancements are a continuation of the teachings found in commonly owned U.S. Patent Publication No. 2007/0298082 and commonly owned U.S. Patent Publication No. 2012/0003366, wherein new methods and devices are provided for forming hydrated alginate, combining hydrated alginate with ingredients to be pelletized and the formation of pellets. While the present invention generally describes articles formed by forming devices, such as pellets, it should be understood that other similar types of mass produced articles could be formed and use of the term pellets should not be considered limiting.

In one aspect, the present invention provides forming devices and methods for the introduction of atomized hydrated alginate to ingredients to be pelletized. In another aspect, the present invention provides forming devices and methods for the pelletization of ingredients, based upon one or more characteristics of the ingredients being pelletized, one or more operating conditions of the forming device or both. Such characteristics may comprise the characteristics of ingredients to be pelletized, temperature of ingredients, moisture of ingredients, particle size of the ingredients, oil or fat content of the ingredients, percentage make-up of the ingredients that comprise hydrated alginate, or otherwise described herein. Such operating conditions may comprise temperature, humidity or moisture within the forming device, such as a preconditioning chamber or inputs from other areas of a forming device, or otherwise described herein.

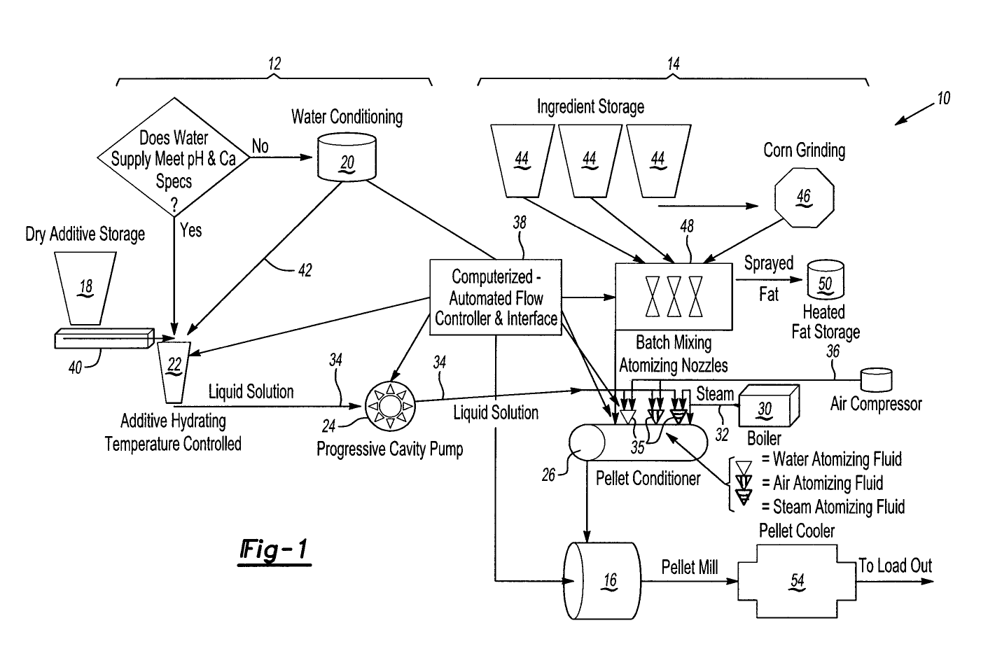

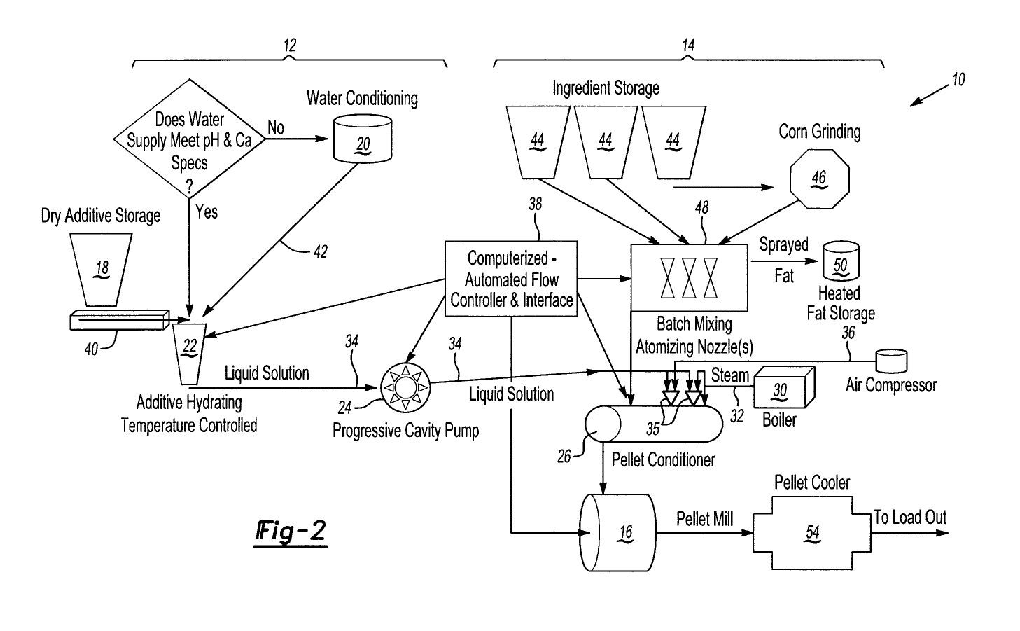

Referring to FIGS. 1 and 2, schematic views of several exemplary pelletization systems 10 of the present invention are shown. The systems include a retention agent forming station 12 and a pellet forming station 14. However, it should be appreciated that the stations 12, 14 may be combined or one or more components of the stations 12, 14 may be separated. Further, in the exemplary embodiments shown, the pellet forming station 14 includes a forming device 16, such as a pellet mill, however it should be appreciated that other forming devices, particularly high production forming devices, such as extruders, pelletizers, tablet making equipment or otherwise, are possible.

The system 10 includes a dry alginate storage tank 18 and hydration storage tank 20 or hydration supply, e.g. hose or otherwise. The dry alginate and hydration storage tanks 18 and 20 are in communication with a retention agent storage tank 22. In one exemplary embodiment, the retention agent tank 22 is configured to receive and mix material from the dry alginate and hydration storage tanks 18, 20 to form hydrated alginate. The retention agent storage tank 22 is in communication with the pellet forming station 14 for application to ingredients to be pelletized, as further described herein. In one particular configuration, the system 10 includes a pump 24 for movement of hydrated alginate from the retention agent storage tank 22 to the pellet forming station 14.

The hydrated alginate is applied to the ingredients while in one or more components of the forming device 16. It is also contemplated that the hydrated alginate can be injected at a single location or multiple locations. Such multiple locations may include a single components of the forming device 16 or multiple components of the forming device. Such components may comprise a conditioning chamber, preconditioning chamber, feed screw, or otherwise. It is further contemplated that the hydrated alginate may be sprayed directly on ingredients to be pelletized or may be added to another fluid, such as steam, and subsequently added to the ingredients to be pelletized. It is contemplated that in one exemplary embodiment the hydrated alginate is atomized prior to combining with another fluid.

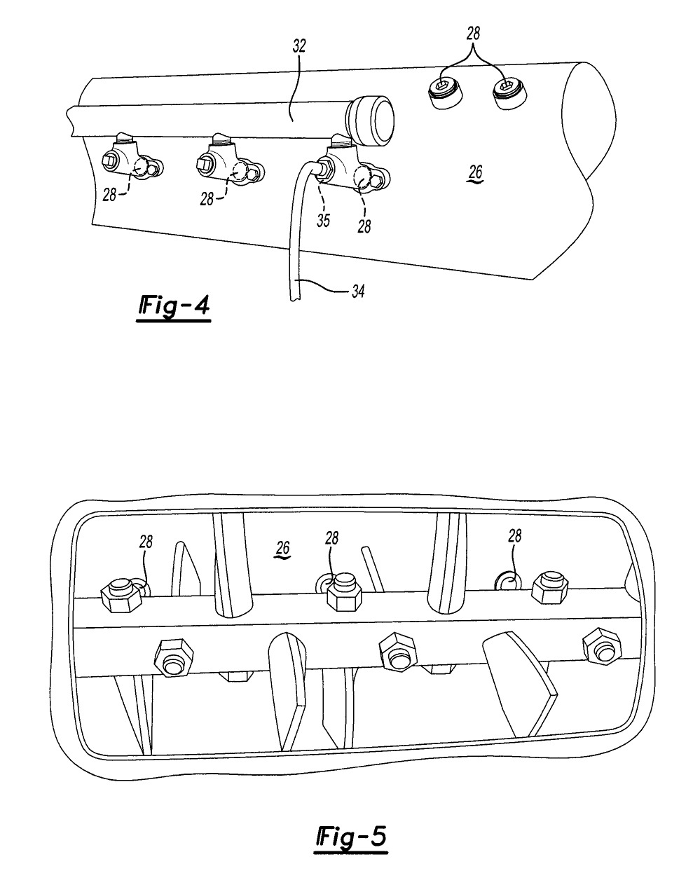

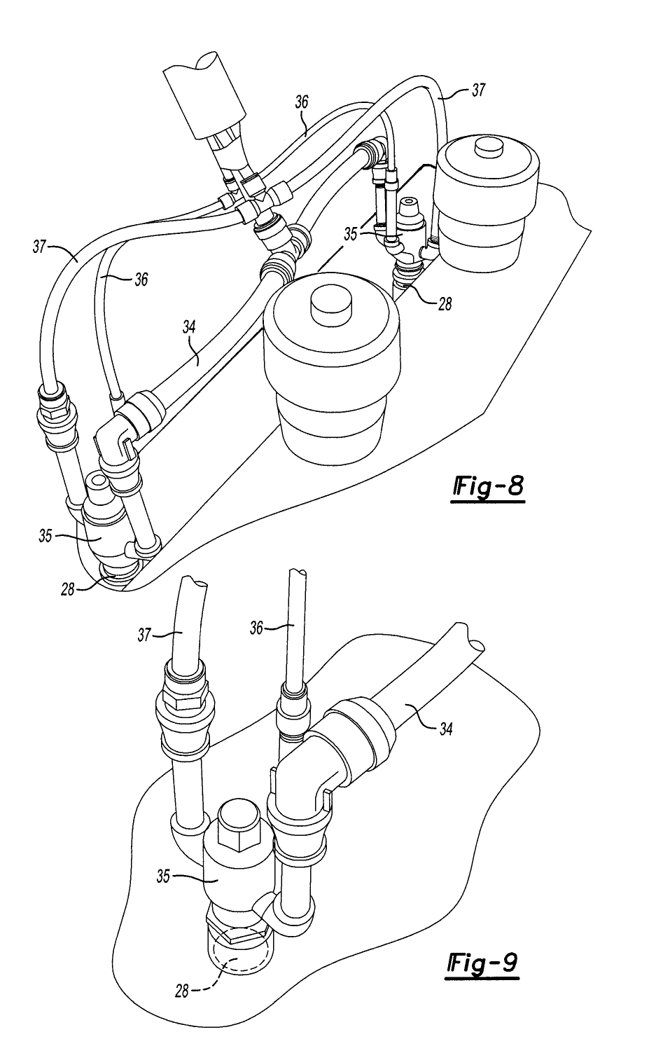

In a first exemplary embodiment, referring to FIGS. 4 and 5, the hydrated alginate is directly injected into a conditioning chamber 26 of the forming device 16, via hydrated alginate conduit 34, through one or more ports 28 disposed along the conditioning chamber. In this configuration, the ports 28 comprise steam ports utilized for the introduction of steam within the conditioning chamber 28. The steam ports 28 are in communication with a steam supply 30 through a stream supply conduit 32. Advantageously, this provides the ability to adapt or retrofit an existing conditioning chamber 26 or forming device 16 to inject hydrated alginate onto the ingredients. In a second exemplary embodiment, referring to FIGS. 8 and 9, it is contemplated that the hydrated alginate is injected through ports 28 formed through the conditioning chamber 26 of the forming device 16. In this configuration the openings and associated fasteners are formed or mounted along the side wall of the conditioning chamber 26. In a third exemplary embodiment, referring again to FIGS. 4 and 5, existing unused ports 28 are utilized to connect a hydrated alginate supply for injection into the conditioning chamber 26 or otherwise.

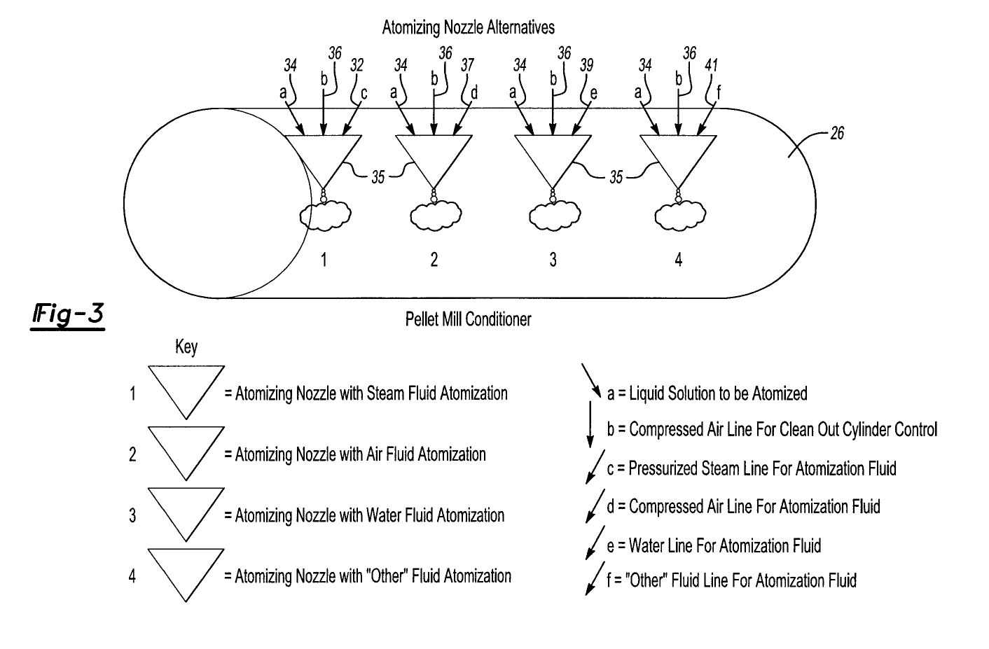

In certain exemplary embodiments it is contemplated that the alginate is combined with fluids, such as air, steam, water, gas or other fluid. In one exemplary embodiment such fluids are used as a means for atomization of the alginate. For example, with reference to FIG. 3, four different non-limiting examples of fluids are shown, which in certain exemplary embodiments are used for atomization. In the first example shown, hydrated alginate is mixed with steam. In a second example, hydrated alginate is mixed with air. In a third example, hydrated alginate is mixed with water. In a fourth example, hydrated alginate is mixed with a gas, such as hydrogen, nitrogen or otherwise. In each of these examples, it is also possible that the atomization fluid is configured to provide hydration or additional hydration to the alginate. As such, in certain exemplary embodiments the alginate being combined with the atomization fluid may be dry or partially hydrated. It should be appreciated that the additional hydration results in viscosity change the may be used to improve atomization of the alginate, distribution of the alginate or both.

In one particular exemplary embodiment, the hydrated alginate is atomized with a suitable atomization nozzle 35 prior to application to the ingredients. Such suitable atomization nozzles 35 include internal mix nozzles and external mix nozzles. Further, atomization can be achieved through hydraulic atomization where pressurized hydrated alginate is sheared and/or pulverized through impacting surfaces of a nozzle and by the configuration of the nozzle. Atomization can also be achieved through fluid atomization where atomization is achieved by colliding an atomization fluid with hydrated alginate. The hydrated alginate or blended injectable formulation or otherwise can be atomized with an atomizing fluid such as steam, air, or other gaseous or fluidic flow means to internal mix nozzle atomization physics and sciences. Advantageously, atomization of the alginate improves distribution of the hydrated alginate to the ingredients thereby improving even application of the hydrated alginate. Atomization of the hydrated alginate formulation allows for optimization of mixing and coating by smaller droplet particles of the hydrated alginate formulation to be more reliably blended and mixed within the base material mixture prior to forming or pelletization.

In one exemplary embodiment, particle size of the atomized fluid is adjustable to provide optimized distribution to the ingredients. This is accomplished by the atomization system being able to control both the fluidic flow and pressure of the hydrated alginate formulation in relation to the flow and pressure of the atomizing fluid, when used. Optimization of the particle size of the hydrated alginate formulation equates to improved mixing, coating, lubrication and adhesion of the materials being formed as they move through the forming device. Optimization of particle size can result in significantly less alginate inclusion rates resulting in significant cost savings, improved adhesive binding of the blended materials, enhanced lubricity of the material being formed through improved coating of the particulate matter and other advantages. Further, particle and formulation droplet size can be managed based on the ideal characteristics of the materials or additives blended within the hydrated alginate solution to best control the application of the hydrated solution to maximize costs saving, application efficiencies, and chemical and physical characteristics of the additives beyond the effects of the hydrated alginate formulation.

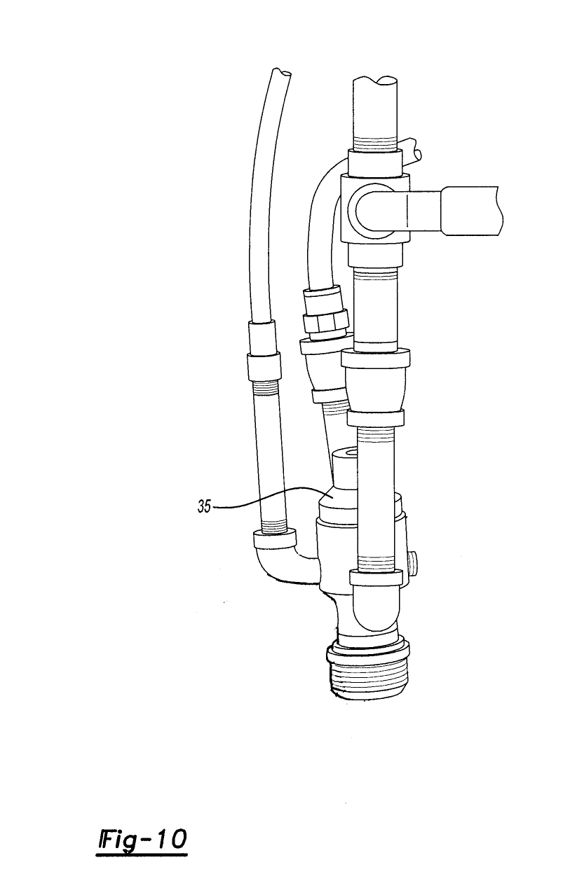

The present invention contemplates different atomization nozzle configurations for different applications or desired results. Examples of suitable atomization nozzles and nozzle configurations are shown in FIGS. 7 and 10 as well as in other figures. Specific examples of commercially available atomization nozzles include models SU22 and SU42 provided by Spray Systems, Inc.

In a first exemplary configuration, referring to FIGS. 4 and 5, the hydrated alginate is atomized upstream from a steam supply conduit 32 and port 28. In this configuration, it is contemplated that nozzle is remotely located with respect to the conditioning chamber 26 or forming device 16 and delivered thereto under pressure. Alternatively, still referring to FIG. 4, a suitable atomization nozzle 35, particularly a hydraulic atomization nozzle, may be place proximate port 28, as indicated in phantom.

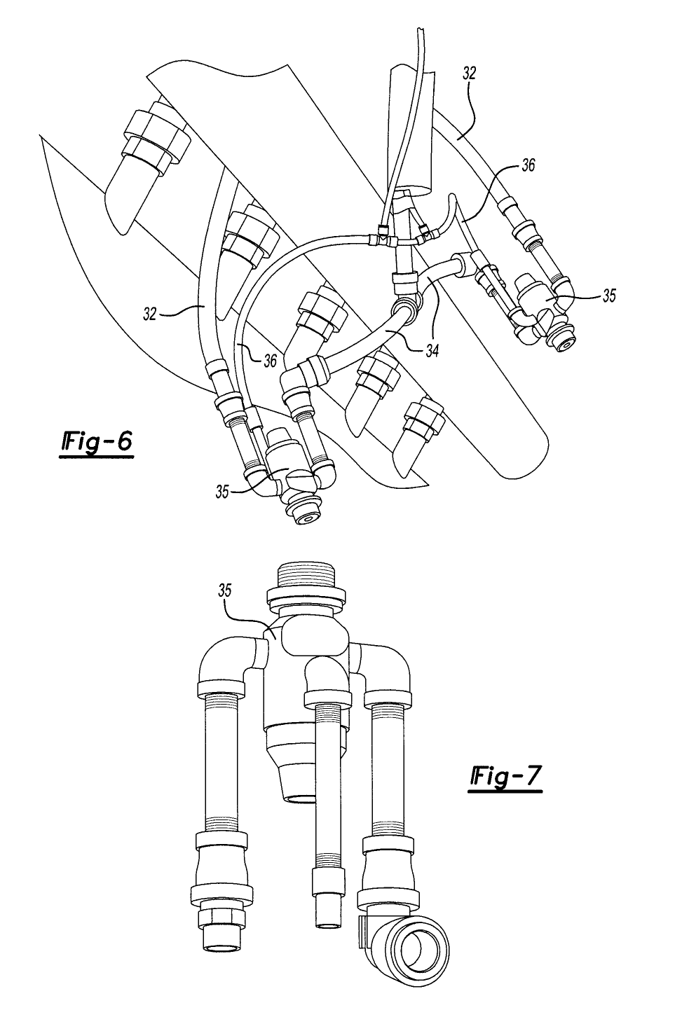

In a second exemplary configuration, referring to FIG. 3, example 1, and FIGS. 6 and 7, the hydrated alginate is atomized with steam. In this configuration an atomization nozzle 35 is in fluid communication with a steam supply 30, via a steam supply conduit 32, and the retention agent storage tank 22, via hydrated alginate conduit 34. The nozzle 35 is in further fluid communication with an air supply, via air conduit 36, for controlling opening, closing and cleanout of the atomization nozzle 35. Alternatively, actuation of the nozzle, or any other nozzle described herein may alternatively be achieved through electric solenoid action, mechanical spring means or otherwise. In operation, as the atomizing fluid, i.e. steam, enters nozzle 35, via steam supply conduit 32, the shear and impact velocity and pressure of the atomizing fluid and configuration of the nozzle causes particles of the hydrated alginate and water from the steam to be pulverized, sheared and atomized into droplets of specific size. For example, higher velocities and greater impacts of atomizing fluid with the hydrated alginate or higher velocities and greater impacts of the hydrated alginate with surfaces of nozzle 35 will cause increased pulverization and result in smaller droplet size. Conversely, lower velocities and smaller impacts of atomizing fluid with the hydrated alginate or lower velocities and smaller impacts of the hydrated alginate with surfaces(s) of nozzle 35 will decrease pulverization and result in larger droplet size. It should be appreciated that the droplet size can be modified with any of the examples described herein. The atomized hydrated alginate enters into the forming device 16, such as into conditioning chamber 26 through port 28, to be combined with the ingredients therein.

In a third exemplary configuration, referring to FIG. 3, example 2, and FIGS. 8 and 9, the hydrated alginate is atomized with air. In this configuration an atomization nozzle 35 is in fluid communication with an air supply, via an air supply conduit 37, and the retention agent storage tank 22, via hydrated alginate conduit 34. The nozzle 35 is in further fluid communication with another air supply, via air conduit 36, for controlling opening, closing and cleanout of the atomization nozzle 35. In operation, as the atomizing fluid, i.e. air, enters nozzle 35, via air supply conduit 37, the shear and impact velocity and pressure of the atomizing fluid and configuration of the nozzle causes particles of the hydrated alginate to be pulverized, sheared and atomized into droplets of specific size. The atomized hydrated alginate enters into the forming device 16, such as into conditioning chamber 26 through port 28, to be combined with the ingredients therein.

In a fourth exemplary configuration, referring to FIG. 3, example 3, the hydrated alginate is atomized with water. In this configuration an atomization nozzle 35 is in fluid communication with a water supply, via a water supply conduit 39, and the retention agent storage tank 22, via hydrated alginate conduit 34. The nozzle 35 is in further fluid communication with an air supply, via air conduit 36, for controlling opening, closing and cleanout of the atomization nozzle 35. In operation, as the atomizing fluid, e.g. water, enters nozzle 35, via water supply conduit 39, the shear and impact velocity and pressure of the atomizing fluid and configuration of the nozzle causes particles of the hydrated alginate and water to be pulverized, sheared and atomized into droplets of specific size. The atomized hydrated alginate enters into the forming device 16, such as into conditioning chamber 26 through port 28, to be combined with the ingredients therein.

In a fifth exemplary configuration, referring to FIG. 3, example 4, the hydrated alginate is atomized with another fluid, liquid or gas, such as nitrogen or otherwise. In this configuration an atomization nozzle 35 is in fluid communication with a fluid supply, via fluid supply conduit 41, and the retention agent storage tank 22, via hydrated alginate conduit 34. The nozzle 35 is in further fluid communication with an air supply, via air conduit 36, for controlling opening, closing and cleanout of the atomization nozzle 35. In operation, as the atomizing fluid enters nozzle 35, via fluid supply conduit 41, the shear and impact velocity and pressure of the atomizing fluid and configuration of the nozzle causes particles of the hydrated alginate to be pulverized, sheared and atomized into droplets of specific size. The atomized hydrated alginate enters into the forming device 16, such as into conditioning chamber 26 through port 28, to be combined with the ingredients therein.

In the above nozzle examples, the pressure of the hydrated alginate, atomization fluid and air for control of the nozzle are such so as to achieve a desired spray pattern of atomized fluid. The pressure of the hydrated alginate can also be based upon viscosity of the hydrated alginate, volume flow rate of the atomization fluid or otherwise. It is contemplated that the pressure of the hydrated alginate is between about 0 to 15 psi, 15 to 35 psi, 35 to 90 psi or otherwise.

The rate of hydrated alginate being applied to the ingredients can be based upon one or more factors to maximize efficiency and effectiveness. For example, the rate of hydrated alginate being added to the ingredients can be based upon one or more characteristics of the ingredients of the hydrated alginate formulation, viscosity or thickness of the resultant formulation or lubricity, adhesion as predicated upon the desired outcome to the mixture being formed by the device, one or more operating conditions of the forming device or combinations thereof.

For example, with respect to the former condition, the rate of hydrated alginate can be based upon characteristics of the ingredients such as: i) percentage of different types of ingredients within the overall ingredient, such as fat percentage, carbohydrate percentage, protein percentage, medicinal ingredients or otherwise, ii) temperature of ingredients, iii) humidity, moisture or water content of ingredients, iv) particle size of the ingredients, heat sensitivity of the ingredients, general ease of traditional pellet formation of the ingredients, or otherwise.

With respect to the later condition, the rate of hydrated alginate can be based upon operating conditions of the forming device such as: i) flow rate of ingredients through the forming device, ii) flow rate, temperature and/or pressure of steam being injected into the ingredients, iii) temperature of forming device, iv) humidity level within the forming device, v) ingredient size being formed, density, durability, or surface characteristics of the formed mixture, or otherwise.

With respect to the aforementioned ingredient characteristics and operating conditions, it is contemplated that the forming device may include one or more sensing devices. For example, in one exemplary embodiment the system 10 includes a temperature probe for monitoring the temperature of the ingredients or temperature within the forming device 16. An example of a suitable temperature probe comprises resistance temperature detection (RTD) probe. In another exemplary embodiment, the system 10 includes a moisture probe for monitoring moisture content of the ingredients and/or humidity within the forming device 16. An example of a suitable moisture probe comprises ultrasonic moisture sensing device, manufactured by Hydronix . Other sensors are possible. As previously mentioned, in one exemplary embodiment, the volume flow rate of alginate or hydrated alginate is based upon or more monitored characteristics of ingredients and/or operating conditions of the forming device 16 to provide optimized hydration and retention. In view of the forgoing, the present invention further contemplates a real-time interactive monitoring and alginate additive system for the forming device. It has been discovered that real-time monitoring of characteristics of ingredients and/or operation of the forming device provides the ability to provide prescribed amounts of hydrated alginate to provide both suitable retention of ingredients and sufficient lubrication during forming Also, this feature allows a user to choose priority with respect to quality of pellet, speed of pelletization, power consumption, and/or die life of the forming device. Still further, this features provides the ability to configure the hydrated alginate, and application thereof, based upon desired steam application (e.g. amount, pressure temperature or otherwise), ingredient selection (percentage of fat, carbohydrates, protein or otherwise within the ingredient hydrated formulation), compression rate of ingredients, temperature of ingredient (which is highly desirable when using temperature sensitive ingredients, such as certain enzymes, minerals, vitamins, proteins, probiotics, antibiotics, disinfectants, medications, oils and alcohol), or otherwise.

To this extent, in one exemplary embodiment, it is contemplated that the system further includes a controller 38 for receiving information pertaining to the characteristics of the ingredients and/or operation condition of the forming device 16 and adjusting the volume flow rate, pressure or otherwise of alginate or hydrated alginate to the ingredients to obtain the aforementioned advantages. In another exemplary embodiment, it is further contemplated that the controller is in communication with the dry alginate storage tank 18, hydration storage tank 20, retention agent storage tank 22, one or more metering devices, or otherwise, for determining and/or controlling the characteristics of the hydrated alginate. For example, the type and percentage of dry alginate, temperature and percentage of hydrating means (e.g. water or otherwise), whether other additives exist in the hydrated alginate or otherwise. With this information, the controller controls metering of hydrated alginate to the ingredients to optimize hydration and retention of the ingredients based upon a user needs.

The controller 38 provides both the ability to monitor the status of components of the pelletization system 10, to control operation of components of the pelletization system 10 or both. Such components include components of the retention agent forming station 12 and the pellet forming station 14. For example, it is contemplated that the controller monitors levels of dry alginate, hydration means and hydrated alginate. It is further contemplated that the controller controls dispensing and mixing of dry alginate, hydration means and hydrated alginate. It is also contemplated that the controller 38 controls volumetric fluid flow rates and pressures through nozzles 35. It is also contemplated that the controller controls injection and injection characteristics of the hydrated alginate, steam and atomization fluid into the forming device 16, conditioning chamber 26 or otherwise. It is further contemplated that the controller controls dispensing of mixing and dispensing of ingredients into the forming device or conditioning chamber, pelletization, temperature and humidity levels or otherwise. In one exemplary embodiment, all or a portion of the controller 38 is remotely located with respect to the pelletization system 10 to allow monitoring and control of the pelletization system 10 at another location. In one particular exemplary embodiment, the controller 38 communicates with components of the pelletization system 10 over the internet or another network communication infrastructure. Accordingly, the controller 38 is configured to receive signals from a user (e.g. manual or electrical signals) or signals (e.g. electrical optical or otherwise) corresponding to operating condition of one or more components of the pelletization system 10, e.g. retention agent forming station 12, pellet forming station or otherwise. The controller 38 is further configured to generate signals (e.g. electrical, mechanical optical or otherwise), configured to control operation of one or more components of the pelletization system 10, e.g. retention agent forming station 12, pellet forming station or otherwise, based upon signals received from a user or otherwise.

The characteristics of the hydrated alginate may vary between applications. As mentioned above, the hydrated alginate may change in terms of alginate and water percentages, temperatures, additives or otherwise to meet the real-time needs of the forming device or user for the purpose of lubrication and retention optimization or other characteristics of the formed material. In one exemplary embodiment, the hydrated alginate comprises between about 0.5% to 7.5%, between about 1.25% to 5.6%, or between about 2.5% to 3.74%, by weight of dry alginate of the hydrated alginate. In another exemplary embodiment, it is contemplated that the hydrated alginate comprises between about 92.5% to 99.5%, between about 94.6% to 98.75%, or between about 96.26% to 97.5%, by weight of hydration means (e.g. water or otherwise) of the hydrated alginate. In another aspect, it is contemplated that the combined ingredients and hydrated alginate comprises between about 0.001% to 1%, between about 0.005% to 0.45%, or between about 0.02% to 0.075%, by weight of dry alginate of the combined ingredients and hydrated alginate. With respect to water, it is contemplated that the hydration means added to the hydrated alginate, or the hydrated alginate itself, has a temperature of between about 32° F. to 212° F., between about 40° F. to 200° F., between about 50° F. to 150° F., or between about 70° F. to 110° F. It is further contemplated that the hydrated alginate, ingredients or both may include one or more of the following additives for improving characteristics of the resulting pellet: surfactants or emulsifying agents, mineral oil, vegetable oils (i.e. corn, canola, soy, etc.), calcium salts, magnesium salts, flavoring agents, marking or coloring (e.g. dye) agents, enzymes, biological markers, acidifiers, bases, calcium chelating agents, or otherwise.

Examples of suitable dry alginate that may be used with the present invention can be found in commonly owned U.S. Patent Publication No. 2007/0298082 and commonly owned U.S. Patent Publication No. 2012/0003366. Examples of suitable hydration means include water, or otherwise. It is further contemplated that the water may comprise or be altered to include a particulate pH balance, such as between 4 pH and 10 pH, include particular vitamins and/or minerals or otherwise be particularly suited for the application of the pellets.

In view of the foregoing, referring to FIGS. 1 and 2, exemplary systems and methods of pelletization are shown. The systems 10 are shown separated in a retention agent forming station 12, which may comprise or include any of the components of the retention agent forming station as shown and described in commonly owned and co-pending U.S. Patent Publication No. 2012/0003366, and a pellet forming station 14, which also may comprise or include any of the components of the pellet forming station/device shown and described in commonly owned and co-pending U.S. Patent Publication No. 2007/0298082. It should be appreciated that the separation of stations is for illustrative purposes only and components can be combined and/or interchanged.

In the exemplary embodiments shown, dry alginate is transported from the dry alginate storage tank 18 to the retention agent storage tank 22, via a conveyer 40 or other suitable delivery means. Similarly, hydration means is also transported from the hydration storage tank 20, or other suitable hydration supply, to the retention agent storage tank 22, via a hydration conduit 42 or other suitable delivery means.

Metering of the dry alginate and hydration means is performed via controller 38 accordingly to desired operation of the system 10, as described herein, i.e. accordingly to user priority or otherwise. Also, the hydration means can be tested to ensure desired pH and calcium levels, or other levels, are in desired ranges.

After mixing, the hydrated alginate is transported to the pellet forming station 14 through suitable hydrated alginate conduits 34, via pump 24. Operation of the pump and metering of the hydrated alginate is controlled through controller 38. In the particular exemplary embodiment shown, the hydrated alginate is pumped to conditioning chamber 26.

The ingredients used for pelletization are stored in storage bins 44 and may utilize a grinder 46 for pulverization of particular ingredients, such as corn or otherwise. The ingredients are deposited into a mixer 48 where additional ingredients may be added, such as heated fats from a storage container 50. Metering of the ingredients into the mixer is controlled through controller 38. The combined ingredients are mixed within the mixer and deposited into conditioner 26, wherein metering is controlled via controller 38.

The ingredients deposited in the conditioning chamber 26 are conditioned with a mixture of atomized steam and hydrated alginate. More particularly, a plurality of nozzles 35 are disposed along the conditioning chamber 26 at ports 28. The nozzles 35, which are in communication with steam supply 30, via steam or atomizing fluid conduit 32, and retention agent storage tank 22, via hydrated alginate conduit 34, and an air supply, via air conduit 36, are configured to atomize the hydrated alginate and steam and inject the combined atomized fluid into the conditioning chamber 26. In one exemplary embodiment, the conditioning chamber 26 includes a mixer for providing even distribution of the atomized fluid to the ingredients therein. Metering of atomized fluid and mixing of ingredients is controlled through controller 38.

The conditioned ingredients including a thorough mixture of hydrated alginate is deposited into the forming device 16, e.g. pellet mill, where it is formed into individual article, e.g. pellets. Depositing and pelletization is also controlled through controller 38. Upon pelletization, the individual articles are cooled, via cooler 54, and packaged. It should be appreciated that more or less steps may be used as shown and described herein.

While the invention has been described with reference to a preferred embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A process of forming animal feed, the process comprising:
forming a mixture of hydrated alginate;
forming a mixture of ingredients to be pelletized, the mixture of ingredients being placed in a preconditioning chamber of a forming device;
atomizing and injecting the hydrated alginate into the preconditioning chamber to coat the mixture of ingredients; and
pelletizing the mixture of alginate coated ingredients,
wherein the volume of atomized hydrated alginate applied to the mixture of ingredients is based upon one or more characteristics of the ingredients, one or more operating conditions of the forming device or both.

2. The process of claim 1, wherein atomization of the hydrated alginate is performed with a nozzle.

3. The process of claim 2, wherein the nozzle comprises an internal mix atomization nozzle.

4. The process of claim 2, wherein the nozzle comprises an external mix atomization nozzle.

5. The process of claim 2, wherein the nozzle is fluidly connected to the hydrated alginate and an atomization fluid.

6. The process of claim 5, wherein a controller communicates with a fluid pump that meters fluid flow of the hydrated alginate to the nozzle.

7. The process of claim 6, wherein the controller controls pressure, volume flow rate or both of the hydrated alginate.

8. The process of claim 7, wherein the controller controls pressure, volume flow rate or both of an atomization fluid.

9. The process of claim 7, wherein the controller controls droplet size of the atomized hydrated alginate.

10. The process of claim 9, wherein the controller functions on a real-time basis based upon moisture of the second ingredients before, during or after pelletization.

11. The process of claim 1, wherein formation of the hydrated alginate mixture is controlled by the controller, and wherein the controller controls viscosity of the hydrated alginate mixture, temperature of the hydrated alginate mixture or both based upon operating conditions of the forming device or characteristics of the ingredients.

12. The process of claim 1, wherein hydrated alginate is atomized with air and is combined with steam.

13. The process of claim 1, wherein hydrated alginate is atomized with steam.

14. The process of claim 1, wherein a controller is in communication with one or more components of a retention agent forming station, one or more components of a pellet forming station or combinations thereof.

15. The process of claim 14, wherein the controller receives signals from the one or more components of the retention agent forming station, the pellet forming station or combinations thereof indicating operating status thereof, and wherein the controller transmits signals to the one or more components of the retention agent forming station, the pellet forming station or combinations thereof for controlling operation thereof.

16. The process of claim 1, wherein the controller monitors operational status of the forming device used to pelletize the mixture of alginate coated ingredients.

17. The process of claim 1, wherein the one or more characteristics of the ingredients comprises moisture level of the ingredients, temperature level of the ingredients or both.

18. The process of claim 1, wherein the one or more operating conditions of the forming device comprises temperature level within the forming device, humidity level within the forming device, volume flow rate of ingredients through the forming device, or combination thereof.

19. A pelletization system for mass production of articles, the system including:
a hydration unit configured to receive and mix an alginate powder with a hydration fluid to form a hydrated alginate mixture;
a preconditioning chamber for treatment of ingredients to be pelletized, the preconditioning chamber including a plurality of atomization nozzles fluidly connected to the hydration unit for atomization and injection of the hydrated alginate mixture onto the ingredients within the preconditioning chamber; and
a forming device linkably attached to the preconditioning chamber to receive ingredients therefrom, the forming device being configured to form articles from the ingredients received from the preconditioning chamber.

20. The system of claim 19, further comprising an atomization fluid supply, the atomization nozzles being in fluid communication with the atomization fluid supply.

21. The system of claim 20, wherein the atomization fluid supply comprises a steam supply.

22. The system of claim 20, wherein the atomization fluid supply comprises an air supply.

23. The system of claim 19, further comprising a controller for controlling atomization of the hydrated alginate mixture, forming of articles by the forming device or both.
